(19) United States
(12) Patent Application Publication
(10) Pub. No.: US 2007/0171386 A1
(43) Pub. Date: Jul. 26, 2007

(54) PROJECTOR HAVING BRIGHTNESS-ADJUSTING MODULE AND METHOD FOR ADJUSTING BRIGHTNESS FOR THE SAME

(75) Inventors: Wen Chin Cheng, Hsinchu City (TW); Han Chung Chang, Taichung County (TW)

Correspondence Address: CONNOLLY BOVE LODGE & HUTZ LLP, P.O. BOX 2207, WILMINGTON, DE, 19899-2207, US

(73) Assignee: LUMENS DIGITAL OPTICS INC., Jhupei City (TW)

(21) Appl. No.: 11/308,435

(22) Filed: Mar. 24, 2006

(30) Foreign Application Priority Data
Jan. 25, 2006 (TW) 095102787

(51) Int. Cl. G03B 21/20

(52) U.S. Cl. 353/85

(57) ABSTRACT

A projector comprises a light-emitting device for generating light beams, a reflector for focusing the light beams to a predetermined region, a light integrator positioned at the predetermined region and a brightness-adjusting module for adjusting the brightness of the projector by changing the relative distance of the reflector and the light integrator. Preferably, the reflector is an elliptical reflector having two foci, the light-emitting device is positioned at one of the two foci and the other focus is laid in the predetermined region. The present method for adjusting the brightness of a projector is characterized in adjusting the distance between the light integrator and the reflector to adjust the brightness of the projector.

### BACKGROUND OF THE INVENTION

(A) Field of the Invention

The present invention relates to a projector having a brightness-adjusting module and method for adjusting brightness for the same, and more particularly, to a projector having a brightness-adjusting module configured to adjust an output brightness by changing the position of a light integrator with respect to a reflector of the projector and method for the same.

(B) Description of the Related Art

Among many large-sized billboards, the video wall has been widely used in some populous areas to attract consumers' attention by the excellent audio-visual effect of the video wall so as to achieve maximum advertisement exposure.

FIG. 1 illustrates a conventional video wall 60. The video wall 60 comprises four display units 62A, 62B, 62C and 62D, and the video wall 60 divides an original image frame 70 into four sub-image frames 72A, 72B, 72C and 72D, which are displayed in the four display units 62A, 62B, 62C and 62D. Consequently, the original image frame 70 is displayed on the four units 62A, 62B, 62C and 62D in a four-fold size manner. The brightness of these four display units 62A, 62B, 62C and 62D must be uniform to show a high quality image; however, each display unit 62A, 62B, 62C and 62D may contain an internal device different from that of the other display units. This difference causes variations in brightness and reduces image quality.

Conventional technique adjusts the brightness of the four display units 62A, 62B, 62C and 62D by changing the power of the light-emitting device such as a lamp burner of the display unit. However, this technique offers only a small tuning range, which does not meet the practice requirement.

### SUMMARY OF THE INVENTION

The primary objective of the present invention is to provide a projector having a brightness-adjusting module and method for the same, which change the position of a light integrator with respect to a reflector to adjust the output brightness of the projector so as to show an excellent image having a uniform brightness.

In order to achieve the above-mentioned objective and avoid the problems of the prior art, one embodiment of the present invention discloses a projector comprising a light-emitting device including a lamp burner for generating light beams and a reflection unit such as a reflector for focusing the light beams to a predetermined region, a light integrator positioned at the predetermined region and a brightness-adjusting module for adjusting brightness of the projector by changing the position of the reflector with respect to the light integrator. Preferably, the reflector is an elliptical reflector having two foci, with the lamp burner positioned at one of the two foci, and the other focus positioned at the predetermined region. The brightness-adjusting module comprises a platform configured to load the reflector and a moving apparatus configured to move the platform. Particularly, the moving apparatus comprises a rack positioned on a side of the platform, a gear configured to drive the rack through rotation so as to move the platform and a motor configured to drive the gear.

According to another embodiment of the present invention, a method for adjusting the brightness of a projector is characterized by brightness adjustments made by changing the position of a light integrator with respect to a reflector of the projector. The present invention possesses an adjusting range higher than that of the prior art; therefore, the present invention can solve the shortage of different brightness levels among these display units and improve the quality of the displayed image.

### BRIEF DESCRIPTION OF THE DRAWINGS

The objectives and advantages of the present invention will become apparent upon reading the following description and upon reference to the accompanying drawings in which:

FIG. 1 illustrates a conventional video wall; and

FIG. 2 to FIG. 4 illustrate a projector having a brightness-adjusting module according to a preferable embodiment of the present invention.

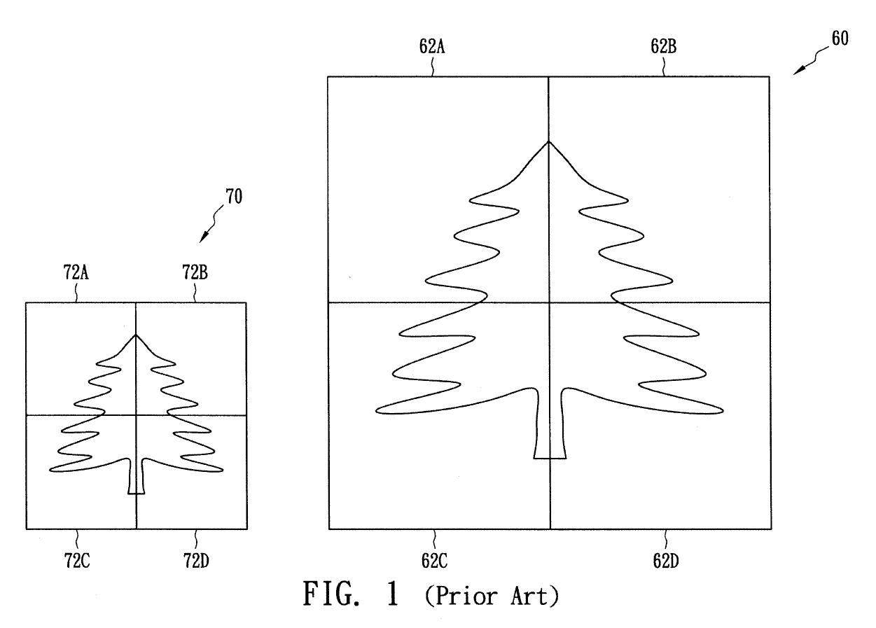

### DETAILED DESCRIPTION OF THE INVENTION

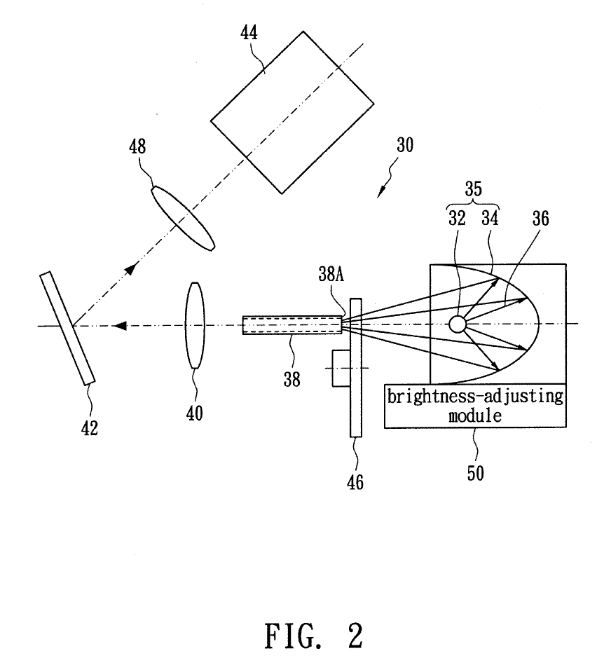

FIG. 2 to FIG. 4 illustrate a projector 30 according to a preferable embodiment of the present invention. The projector 30 comprises a light-emitting device 35 including a lamp burner 32 for generating light beams 36 and a reflector 34 for focusing the light beams 36 to a predetermined region 38A, a light integrator 38 positioned at the predetermined region 38A and a brightness-adjusting module 50 for adjusting the brightness of the projector 30 by changing the position of the reflector 34 with respect to the light integrator 38. The light integrator 38 can be a hollow tube having an inner surface coated by reflective material or a hollow tube undergoing a certain process to create a light-reflecting capability, which can regulate the intensity distribution of the light beams 36.

The projector 30 may further comprise a color wheel 46, relay lens 40, a micromirror device 42, projection lens 48 and an image-displaying device 44 such as a screen of a video wall. Preferably, the reflector 34 is an elliptical reflector having two foci, the lamp burner 32 is positioned at one of the two foci, and the other focus is positioned at the predetermined region 38. The micromirror device 42 can be controlled by digital technique or analog technique.

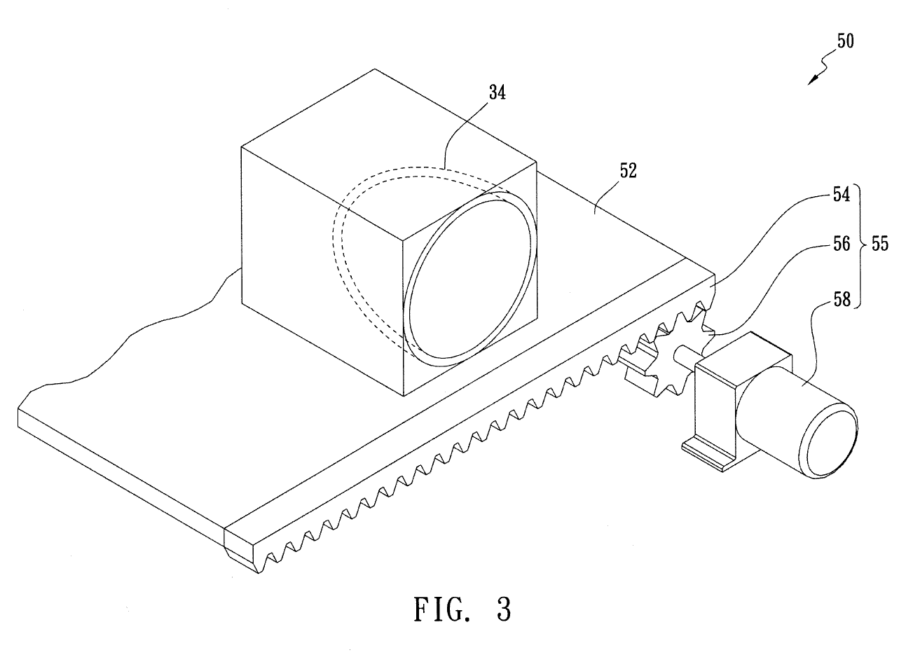

Referring to FIG. 3, the brightness-adjusting module 50 of the present invention includes any moving apparatus capable of moving the reflector 34. In one embodiment, the brightness-adjusting module 50 comprises a platform 52 configured to load the reflector 34 and a moving apparatus 55 configured to move the platform 52. Particularly, the moving apparatus 55 comprises a rack 54 positioned on a side of the platform 52, a gear 56 configured to drive the rack 54 through rotation so as to move the platform 52 and a motor 58 configured to drive the gear 56.

The moving apparatus 55 can be positioned on other sides of the platform 52, i.e., forming a platform capable of moving in a three dimensional manner to change the position of the light integrator 38 with respect to the reflector 34 in a three dimensional manner. In other embodiments, the brightness-adjusting module 50 are the arrangement of slide and platform, and motors or driving units can be used to move the platform up and down, forward and backward, rightward and leftward, or to pull the platform to change the position of the light integrator 38 with respect to the reflector 34.

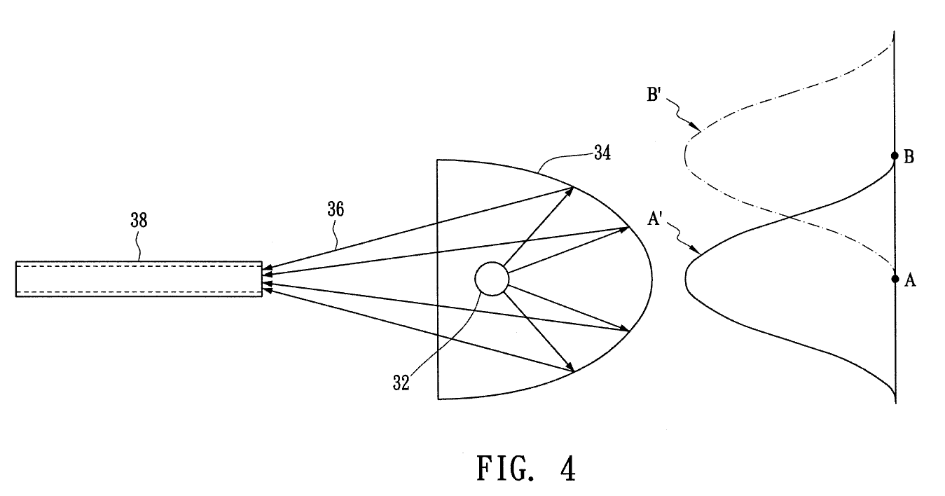

Referring to FIG. 4, the light beams 36 emitted from the lamp burner 32, which is positioned at one of the two foci of the elliptical reflector 32, are collected by the reflector to the light integrator 38 at the predetermined region 38A, and the intensity distribution of the light beams 32 is in a Gaussian manner. The lamp burner 32 is positioned at a vertical position A, its intensity distribution curve is labeled by A′, and the light integrator 38 is positioned at the other focus of the elliptical reflector 32. In case that the light integrator 38 is also positioned at the vertical position A, i.e., the vertical position of the lamp burner 32 is the same as that of the light integrator 38, a portion of the Gaussian distribution curve A′ having a maximum intensity falls in the light integrator 38, and the projector 30 possesses a highest output brightness.

In other cases where the elliptical reflector 34 together with lamp burner 32 therein are moved to another vertical position B (the intensity distribution can be represented by a Gaussian distribution curve B′) by the brightness-adjusting module 50, while the position of the light integrator 38 is kept the same, i.e., changes the position of the elliptical reflector 34 with respect to the light integrator 38. Since the portion of the Gaussian distribution curve B′ having a maximum intensity does not fall in the light integrator 38, the projector 30 possesses a lower output brightness.

In brief, the output brightness of the projector 30 can be increased by changing the position of the elliptical reflector 34 with respect to the light integrator 38 such that the lamp burner 32 at one of the foci of the elliptical reflector 34 and the light integrator 38 at another focus of the elliptical reflector 34 have the same vertical position. Inversely, the output brightness of the projector 30 can be decreased by changing the position of the elliptical reflector 34 with respect to the light integrator 38 such that the vertical position of the lamp burner 32 at one of the foci of the elliptical reflector 34 deviates from that of the light integrator 38 at another focus of the elliptical reflector 34.

In other words, if an offset represents the deviation of the vertical position of the lamp burner 32 from the vertical position of the light integrator 38, increasing the offset decreases the output brightness of the projector 30 and vice versa. Consequently, applying the present invention to the video wall 60 can adjust the brightness of these display units 62A, 62B, 62C and 62D individually by changing the position of the elliptical reflector 34 with respect to the light integrator 38 of the projector 30 positioned in these display units 62A, 62B, 62C and 62D. Consequently, these four display units 62A, 62B, 62C and 62D may have a uniform brightness to show a high quality image.

The above-described embodiments of the present invention are intended to be illustrative only. Numerous alternative embodiments may be devised by those skilled in the art without departing from the scope of the following claims.

What is claimed as new and desired to be protected by Letters Patent of the United States is:

1. A projector, comprising:
a light-emitting device including a lamp burner for generating light beams and a reflector for focusing the light beams to a predetermined region;
a light integrator positioned at the predetermined region; and a brightness-adjusting module for adjusting brightness of the projector by changing the position of the reflector with respect to the light integrator.

2. The projector of claim 1, wherein the reflector is an elliptical reflector having two foci, and the lamp burner is positioned at one of the two foci.

3. The projector of claim 1, wherein the reflector is an elliptical reflector having two foci, and one of the two foci is positioned at the predetermined region.

4. The projector of claim 1, wherein the brightness-adjusting module comprises:
a platform configured to load the reflector; and
a moving apparatus configured to move the platform.

5. The projector of claim 4, wherein the moving apparatus comprises:
a rack positioned on a side of the platform;
a gear configured to drive the rack through rotation so as to move the platform; and
a motor configured to drive the gear.

6. A method for adjusting brightness of a projector, characterized in that the brightness is adjusted by changing the position of a light integrator with respect to a reflector of the projector.

7. The method for adjusting brightness of a projector of claim 6, characterized in that the reflector is an elliptical reflector.

8. The method for adjusting brightness of a projector of claim 7, characterized in that a lamp burner of a light-emitting device is positioned at one of two foci of the elliptical reflector.

9. The method for adjusting brightness of a projector of claim 7, characterized in that the light integrator is positioned at one of two foci of the elliptical reflector.

10. The method for adjusting brightness of a projector of claim 7, characterized in that a lamp burner of a light-emitting device is positioned at one of two foci of the elliptical reflector, and the brightness of the projector is decreased by increasing an offset between the elliptical reflector and the light integrator.

11. The method for adjusting brightness of a projector of claim 7, characterized in that a lamp burner of a light-emitting device is positioned at one of two foci of the elliptical reflector, and the brightness of the projector is increased by decreasing an offset between the elliptical reflector and the light integrator.

12. The method for adjusting brightness of a projector of claim 6, characterized in that changing the position of a light integrator with respect to a reflector of the projector is performed by using a brightness-adjusting module comprising:
a platform configured to load the reflector; and
a moving apparatus configured to move the platform.

13. The method for adjusting brightness of a projector of claim 12, characterized in that the moving apparatus comprises:
a rack positioned on a side of the platform;
a gear configured to drive the rack through rotation so as to move the platform; and
a motor configured to drive the gear.
